(19) United States
(12) Patent Application Publication
(10) Pub. No.: US 2026/0096622 A1
(43) Pub. Date: Apr. 9, 2026

(54) Microshock Prevention Device

(71) Applicant: MSA Technology, LLC, Cranberry Township, PA (US)

(72) Inventors: Thomas Trautzsch, Cranberry Township, PA (US); Celeste L. Hort, Cranberry Township, PA (US); Andrew James Thiel, Wexford, PA (US)

(21) Appl. No.: 18/905,481

(22) Filed: Oct. 3, 2024

(51) Int. Cl. A42B 3/10; H05F 3/04

(52) U.S. Cl. CPC A42B 3/10; H05F 3/04

(57) ABSTRACT

A device comprises a safety helmet, which comprises an outer shell configured for surrounding a head of a wearer, as well as an electrically conductive layer disposed in an interior of the outer shell. The device further comprises an electrostatic discharge (ESD) protection component. This ESD component is positioned in at least a portion of a cavity defined by the interior of the outer shell of the safety helmet. This ESD protection component comprises of a first portion configured to be in contact with the electrically conductive layer of the safety helmet, as well as a second portion configured to be in contact with the wearer. The ESD protection component is configured to provide a path for electric current to flow between the electrically conductive layer and the wearer of the helmet. The ESD component may also be removable, or integrated into a safety harness, which is also disclosed herein.

### CROSS-REFERENCE TO RELATED APPLICATION

The disclosures of U.S. application Ser. No. 17/897,283, titled “Systems and Methods for Providing Reliable Helmet Suspension Installation” filed on 29 Aug. 2022, published as United States Patent Publication 2024/0065362 and U.S. patent application Ser. No. 17/146,711 titled “Safety Helmet” filed on 12 Jan. 2021, now U.S. Pat. No. 12,011,057, are incorporated by reference herein in their entirety.

### BACKGROUND

### Technical Field

The present disclosure relates generally to electrostatic discharge (ESD) protection devices, and in particular to ESD protection devices for integration into safety equipment for use in various situations and environments.

### Technical Description

Electric fields (such as those produced by high voltage overhead power lines) induce charges on the surfaces of objects that are exposed to it. This occurs for any object, including people, that are not grounded (e.g., to the earth) in the presence of the electric field. The induced charge creates a voltage potential on the objects with respect to the earth. When a charged object close to a human body, for example, exceeds the dielectric field strength of air, discharges to the earth via the human body can occur. These discharges are experienced as shocks, or typically microshocks of lesser magnitude, to the human body. Microshocks can be exacerbated when high electric fields are experienced in the presence of metal (e.g., metal tools, safety gear (e.g., harness components, metallic lining within a safety helmet, etc.)). The sensation of a microshock is similar to that caused by static discharge commonly experienced in dry atmospheric conditions after frictional contact with a material (e.g., a nylon carpet or car seat). Microshocks are a common occurrence and are generally regarded as not harmful. That being said, microshocks are reported as causing annoyance in conditions of high electric field strength. Beyond annoyance, microshock discharges can be particularly dangerous in the presence of volatile chemicals, such as explosives or flammable fumes.

### SUMMARY

Generally, the present disclosure provides an improved safety helmet and/or workwear that addresses and/or overcomes some or all of the drawbacks associated with existing safety helmets and/or workwear. In some non-limiting embodiments or aspects, provided is a safety helmet that may have an outer shell configured for surrounding a head of a user, and an electrostatic discharge (ESD) protection component disposed in an interior of the outer shell. The ESD protection component may be configured to provide a path for electric current to flow between an electrically conductive layer of the safety helmet and the wearer of the helmet.

In accordance with some non-limiting embodiments or aspects, the device comprises a safety helmet. This safety helmet comprises an outer shell configured for surrounding a head of a wearer, as well as an electrically conductive layer disposed in an interior of the outer shell. In addition to this helmet, the device further comprises an electrostatic discharge (ESD) protection component. This ESD component is positioned in at least a portion of a cavity defined by the interior of the outer shell of the safety helmet. This ESD protection component comprises of a first portion configured to be in contact with the electrically conductive layer of the safety helmet, as well as a second portion configured to be in contact with the wearer of the helmet. The ESD protection component is configured to provide an equipotential voltage path for electric current to flow between the electrically conductive layer and the wearer of the helmet eliminating the buildup of induced voltages in presence of high electric fields.

In accordance with some non-limiting embodiments or aspects, the first portion of the ESD protection component is configured to contact the skin of the wearer, in particular on the head or neck of the wearer. This first portion, according to some embodiments, comprises a first end, while the second portion comprises a second end.

In accordance with some non-limiting embodiments or aspects, the ESD protection component may comprise circuitry configured to electrically couple the electrically conductive layer to the wearer. This is so that the electrically conductive layer and the wearer have the same voltage potential while the device is in use. According to some embodiments, the device is specifically configured to electrically couple the electrically conductive layer to the wearer inside a high-voltage electric field, which is typical of the conditions experienced by linemen operating on transmission towers or in close proximity to power lines.

In accordance with some non-limiting embodiments or aspects, the path for electric current to flow between the conductive layer of the helmet and the wearer can be improved through increased contact of the ESD component to either the conductive layer or the wearer. For example, according to some embodiments, the ESD protection component is configured to provide 360-degree contact with the wearer. In some embodiments, the ESD protection component is contoured for closer fit with the wearer, and/or the ESD protection component is configured to create a tight seal with the wearer. Generally, the ESD protection component may comprise multiple points of contact with the wearer to ensure the path for electric current to flow stays intact. According to some embodiments, the ESD protection component may further comprise a plurality of materials such as silver-plated nylon thread, carbon-suffused nylon, carbon black-loaded rubber, silver conductive monofilament, conductive foam, semiconductive material, ceramic material, or any combination thereof.

In accordance with some non-limiting embodiments or aspects, the safety helmet can be adapted to accommodate a wide variety of configurations and/or donning preferences. For example, the safety helmet may be either full-brimmed or cap-style, slotted or non-slotted, vented or non-vented, or any combination thereof. According to some embodiments, the helmet is configured for reverse donning. According to yet another embodiment, the ESD protection component can be attached and/or replaced while a suspension system is assembled in the helmet.

In addition to, or separately from, the aforementioned non-limiting embodiments or aspects, the ESD protection component comprises a first portion configured to be removably connected to the electrically conductive layer via an electrically conductive connection mechanism, as well as a second portion configured to be in contact with the wearer of the helmet. Furthermore, the ESD protection component is configured to provide a path for electric current to flow to or from the electrically conductive layer, through the electrically conductive connection mechanism, and from and to the wearer of the helmet.

Under these non-limiting embodiments or aspects, the ESD protection component may further comprise a wide variety of helmet accessories and add-ons, such as at least one of the following: a suspension system, a sweatband, a crown pad, a ratchet pad, a chin-strap, a ratchet assembly, a visor, a visor frame, a face shield, a chin-protector, a brow-guard, a liner, a sunshade, a sun shield, a cooling pad, a goggle retainer, a lanyard, earmuffs, a respirator, or any combination thereof. According to some embodiments, the electrically conductive connection mechanism comprises at least one of the following: a button, a stud, a socket, an eyelet, a snap, a clip, a rivet, a screw, a nail, a staple, a clasp, a pin, a bolt, a buckle, a hook, a zipper, or any combination thereof.

In addition to, or separately from, the aforementioned non-limiting embodiments or aspects, the device further comprises a base layer positioned in at least a portion of a cavity defined by the interior of the outer shell, wherein the ESD protection component is fixedly attached to the base layer.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. Hence, specific dimensions and other physical characteristics related to the embodiments disclosed herein are not to be considered as limiting. Further, it is to be understood that the disclosure may assume various alternative variations and step sequences, except where expressly specified to the contrary.

### BRIEF DESCRIPTION OF THE DRAWINGS

FIG. 1 is a diagram depicting capacitance coupling on the surface of an electrically conductive layer of workwear induced by an electric field.

FIG. 2A is a cut-away profile view of a safety helmet equipped with ESD component coupled to an electrically conductive layer of the helmet in accordance with some non-limiting embodiments or aspects of the present disclosure.

FIG. 2B is a bottom view of a safety helmet equipped with ESD component coupled to an electrically conductive layer of the helmet in accordance with some non-limiting embodiments or aspects of the present disclosure.

FIG. 3 is a cross-sectional view of an embodiment wherein the ESD component is part of a fabric in accordance with some non-limiting embodiments or aspects of the present disclosure.

FIG. 4A is a posterior oblique cutaway view of a safety helmet equipped with ESD component which is integrated within the suspension system of the safety helmet in accordance with some non-limiting embodiments or aspects of the present disclosure.

FIG. 4B is a bottom plan view of a safety helmet equipped with ESD component which is integrated within the suspension system of the safety helmet in accordance with some non-limiting embodiments or aspects of the present disclosure.

FIG. 5A is a close-up diagram of a first variation of an adjustment mechanism that may be part of the suspension system integrated with the ESD component in accordance with some non-limiting embodiments or aspects of the present disclosure.

FIG. 5B is a close-up diagram of a second variation of an adjustment mechanism that may be part of the suspension system integrated with the ESD component in accordance with some non-limiting embodiments or aspects of the present disclosure.

FIG. 5C is a close-up diagram of a third variation of an adjustment mechanism that may be part of the suspension system integrated with the ESD component in accordance with some non-limiting embodiments or aspects of the present disclosure.

FIG. 6 is a cutaway side-view of a safety helmet and a removable and/or disposable sweatband that is oriented for installation within the helmet, wherein the sweatband comprises the ESD component in accordance with some non-limiting embodiments or aspects of the present disclosure.

FIG. 7A is a detached chinstrap comprising fabric straps that are at least partially lined with the ESD component in accordance with some non-limiting embodiments or aspects of the present disclosure.

FIG. 7B is an oblique bottom view of a safety helmet and a chinstrap, wherein the chinstrap is oriented for installation within the helmet, in accordance with some non-limiting embodiments or aspects of the present disclosure.

FIG. 7C depicts a safety helmet complexed with the chinstrap following installation of the chinstrap in accordance with some non-limiting embodiments or aspects of the present disclosure.

FIG. 8 depicts a safety harness comprising the ESD component in accordance with some non-limiting embodiments or aspects of the present disclosure.

### DETAILED DESCRIPTION

Various embodiments or aspects of the present disclosure are directed to a safety helmet and/or workwear having an electrostatic discharge (ESD) protection component configured for reducing the occurrence of microshocks to a user's head and/or body while wearing the safety helmet and/or workwear.

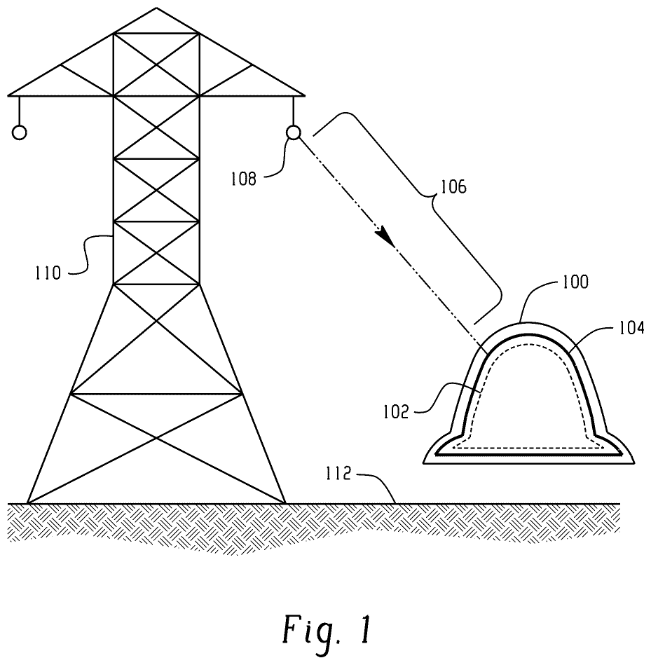

FIG. 1 is a diagram depicting capacitance coupling within electrically conductive workwear 100 induced by an electric field 106. In this particular embodiment, the electric field 106 is generated by a high voltage transmission line 108 of a transmission tower 110. In the embodiment of FIG. 1, the workwear 100 is depicted as being that of a protective safety helmet that might typically be worn by linemen operating on the transmission tower 110. According to the embodiment of FIG. 1, the safety helmet 100 comprises an outer shell configured for surrounding a head of a wearer, as well as an electrically conductive layer 104 (such as an infrared reflective layer as described in U.S. Pat. No. 12,011,057) disposed in an interior of the outer shell. The safety helmet and/or workwear 100 further comprises an electrostatic discharge (ESD) protection component 102. In the embodiment shown in FIG. 1, this ESD component 102 is positioned in at least a portion of a cavity defined by the interior of the outer shell of the safety helmet 100 and the head of the wearer. This ESD protection component 102 comprises of a first portion configured to be in contact with the electrically conductive layer 104 of the safety helmet 100, as well as a second portion configured to be in contact with the wearer of the helmet. In some embodiments, the ESD protection component 102 and/or the electrically conductive layer 104 may comprise a semiconductor device or material.

The ESD protection component 102 is configured to provide a path for electric current to flow between the electrically conductive layer 104 and the wearer of the safety helmet 100, enabling induced electric charges to flow to the ground 112 or some other grounding element. In other words, the ESD protection component 102 is configured to mitigate or eliminate a potential difference between the electrically conductive layer 104 and the wearer of the safety helmet 100. According to some embodiments, the ESD protection component 102 may further comprise circuitry configured to electrically couple the electrically conductive layer 104 to the wearer of the helmet and/or workwear 100. This is so that the electrically conductive layer 104 and the wearer have the same voltage potential while the device is in use. Inside a high-voltage electric field 106 such as that depicted by FIG. 1, the safety helmet and/or workwear 100 is configured to improve comfort to the wearer by preventing microshocks, triboelectric charging, and/or corona discharges from occurring on or near the wearer. According to some embodiments, the ESD protection component 102 is configured to control and/or limit the transfer of coulomb charge to the wearer by maintaining an equipotential between the electrically conductive layer 104 and the wearer, particularly in the presence of high electric fields. In addition to these benefits, the embodiment of the safety helmet 100 depicted by FIG. 1 is configured to provide dielectric protection to the wearer of up to 20,000 volts.

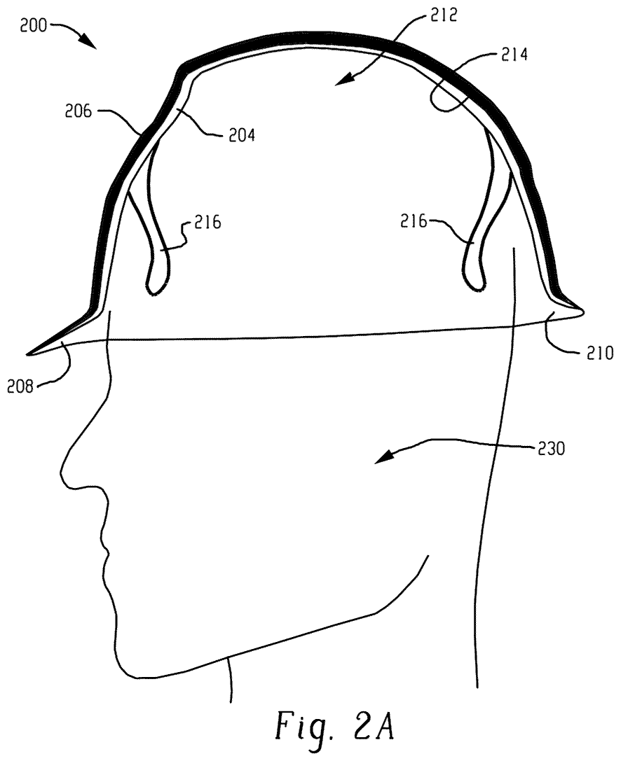

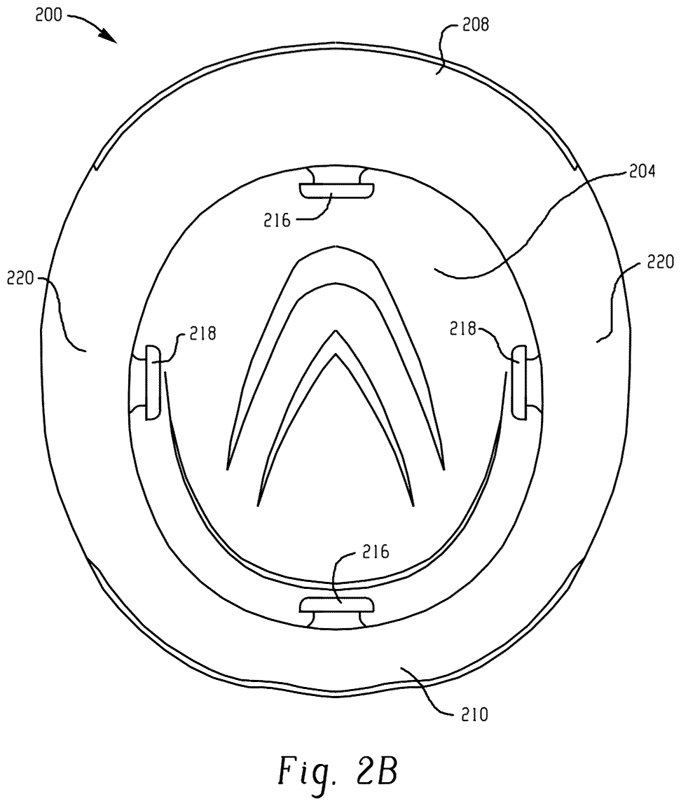

FIG. 2A is a cut-away profile view of a safety helmet 200 equipped with ESD component 102 coupled to an electrically conductive layer 204 of the helmet 200 in accordance with some non-limiting embodiments or aspects of the present disclosure. FIG. 2B is a bottom view of safety helmet 200 equipped with ESD component 102. The safety helmet 200 comprises a rigid outer shell 206 configured to surround a head and/or body 230 of a user. The outer shell 206 has a generally hemi-spherical form and has a facial opening at a front portion 208 configured to be situated above the user's face. The safety helmet 200 also includes an upper portion 212 and a rear portion 210 extending from the upper portion 212 towards the nape of the user's neck. In some non-limiting embodiments or aspects, the electrically conductive layer 204 is provided on at least a portion of an inner surface 214 of the outer shell 206. For example, the electrically conductive layer 204 may be provided on up to 100% of the inner surface 214 of the outer shell 206. According to some embodiments, the dielectric and/or protective properties of the outer shell 206 are not reduced by the electrical connection of the outer shell 206 to the ESD component 102 and/or the electrically conductive layer 204.

As shown in FIG. 2A, the ESD component 102 may comprise a first pair of wings 216 located at the front portion 208 and rear portion 210 of the helmet 200 that are electrically coupled to the conductive layer 204 and extend laterally and/or downwardly from the upper portion 212 towards the head and/or body 230 of the user. As shown in FIG. 2B, a second pair of wings 218 located at lateral sides 220 on each side of the facial opening of the safety helmet 200 may also extend laterally and/or downwardly from the upper portion 212 towards the head and/or body 230 of the user. Each wing of each pair of wings 216 and 218 comprises a first portion comprising a first end that connects to (i.e., is in electrically connection with) the conductive layer 204, and a second portion comprising a second end that contacts (i.e., is in electrical connection with) the head and/or body 230 of the user. In some non-limiting embodiments or aspects, the wings 216 or 218 may have a rounded shape. In use, the first pair of wings 216 may be configured to be in contact with a forehead of the user and a rear of the head of the user, and the second pair of wings 218 may be configured to extend to the temples of the user. It should be noted that the safety helmet 200 may accommodate any number of wings, which may be arranged anywhere along the inner surface 214 and may extend in any direction towards the head and/or body 230 of the user. In use, the safety helmet 200 is configured such that at least one wing is electrically coupled to the conductive layer 204, is in either direct or indirect contact with the skin of the user, thereby forming an electrically conductive path between the conductive layer 204 and the user.

According to some embodiments, the path for electric current to flow between the conductive layer 204 of the helmet and the wearer can be improved through increased contact of the ESD component 102 (including the pairs of wings 216 and 218 as depicted in FIG. 2A and FIG. 2B) to either the conductive layer or the wearer. For example, according to some embodiments, the ESD protection component is configured to provide 360-degree contact with the wearer. In some embodiments, the ESD protection component is contoured for closer fit with the wearer, and/or the ESD protection component is configured to create a tight seal with the wearer. Generally, the ESD protection component may comprise multiple points of contact with the wearer to ensure the path for electric current to flow stays intact. In the embodiment of FIGS. 2A and 2B, the safety helmet 200 comprises at least four discrete points of contact (one for each wing). According to some embodiments, the ESD protection component 102 is in good electrical contact with the conductive layer 204 such that there is no inductance and/or ohms of resistance between the ESD protection component 102 and the conductive layer 204.

In some non-limiting embodiments or aspects, the electrically conductive layer 204 is preferably substantially metallic and may comprise at least one pure metal, such as aluminum, gold, silver, or copper. In other non-limiting embodiments or aspects, the electrically conductive layer 204 may include alloys of aluminum, gold, silver, copper, or any combination thereof. In some non-limiting embodiments or aspects, the electrically conductive layer 204 may contain at least 95 % aluminum by weight. In further non-limiting embodiments or aspects, the electrically conductive layer 204 may be made from one or more of the following materials: doped titanium dioxide, doped or undoped indium tin oxide, doped cerium oxide, doped manganese oxide, iron (III) oxide, cadmium sulfide, chromium trioxide, semiconductive material, ceramic material, or any combination thereof. According to some embodiments, the electrically conductive layer 204 and/or the ESD protection component 102 comprises a conductive foam. In some non-limiting embodiments or aspects, the electrically conductive layer 204 may be a coating that is sprayed on at least a portion of the inner surface 214 of the outer shell 206. For example, the electrically conductive layer 204 may be applied to the inner surface 214 of the outer shell 206 as an atomized spray of aerosolized droplets of metallized paint or ink. According to some embodiments, the electrically conductive layer 204 and/or the ESD protection component 102 further comprises at least one of the following: a rotatable joint, a welding lug, a pivot hinge, a lamp bracket, a cord holder, an attachment rail, a lighting clip, a headlamp strap clip, a stowable slot adaptor, a sliding adjustment blade, or any combination thereof. According to some embodiments, the ESD protection component further comprises a resistor and/or a semiconductor.

The safety helmet 200 can be adapted to accommodate a wide variety of configurations and/or donning preferences. For example, the safety helmet 200 may be either full-brimmed or cap-style, slotted or non-slotted, vented or non-vented, or any combination thereof. In the embodiment of FIGS. 2A and 2B, for example, the safety helmet 200 is full-brimmed. The helmet 200 may also comprise a climbing and/or low-profile design. According to some embodiments, the helmet 200 is configured for reverse donning. According to yet another embodiment, the ESD protection component 102 can be attached and/or replaced while a suspension system is assembled in the helmet, while a brim of the helmet 200 may be textured for added grip when donning or doffing the helmet 200, according to some embodiments. Examples of safety helmets with which the ESD protection component 102 can be used include, but are not limited to, safety helmets sold under the brand names V-Gard®, V-Gard C1®, V-Gard H1™, V-Gard H2™, V-Gard® 500, Topguard®, Smoothdome®, Skullgard®, Super V®, Comfo-Cap®, Thermalgard®, Nexus Climbing®, and Bump Cap which are manufactured and sold by MSA Safety Incorporated of Cranberry Township, Pennsylvania.

According to some embodiments, the workwear (including the embodiment of a safety helmet depicted in FIGS. 2A and 2B) may comprise at least one of the following materials: polyethylene, Acrylonitrile Butadiene Styrene (ABS), Expanded Polystyrene (EPS), polypropylene, POM (Acetal), polyester, acrylic, clear polycarbonate, nylon, glass-reinforced nylon, heat-resistant nylon, High Density Polyethylene (HDPE), flame-resistant Kevlar fabric, phenolic, Polybutylene Terephthalate (PBT), propionate, epoxy-coated steel mesh, heavy-duty anodized aluminum, or any combination thereof. In particular, the ESD protection component 102 may further comprise a plurality of materials such as silver-plated nylon thread, carbon-suffused nylon, carbon black-loaded rubber, silver conductive monofilament, conductive foam, semiconductive material, ceramic material, or any combination thereof.

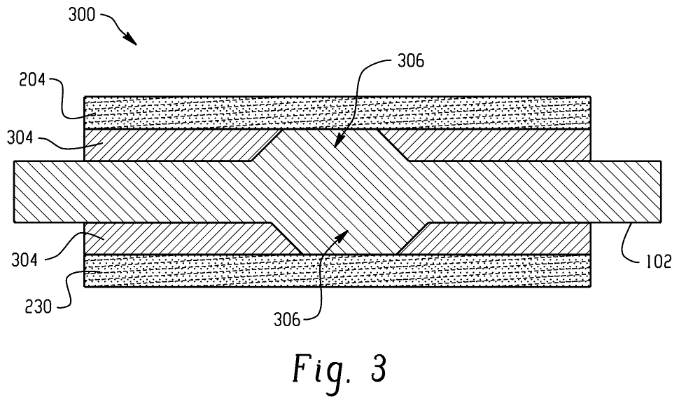

FIG. 3 is a cross-sectional view of an embodiment wherein the ESD component 102 is part of a fabric 300 that interfaces with a user and conductive layer 204 in accordance with some non-limiting embodiments or aspects of the present disclosure. In addition to, or separately from, the aforementioned embodiments, the fabric 300 further comprises a base layer 304 and the ESD protection component 102, wherein the ESD protection component 102 is fixedly attached to the base layer 304. According to at least one non-limiting embodiment, the ESD component 102 may comprise at least one layer of material that is grafted, glued, sewn, or molded onto the base layer 304 to form a flexible material. According to some embodiments, this base layer 304 comprises one or more of the following: a flexible substrate, a textile, an anti-static cloth, a hook-and-loop fastener, knitted ribbon, spandex, or any combination thereof.

The base layer 304 may be attached to one or both sides of the ESD component 102. Likewise, the ESD component 102 may be attached to one or more sides of the base layer 304. Furthermore, the base layer 304 and/or the ESD component 102 may comprise a plurality of layers. There may be one or more openings 306 and/or junctures within the base layer 304 and/or ESD component 102. In use, the fabric 300 is configured such that at least a portion of the surface area of the ESD component 102 is exposed to the conductive layer 204 while being in either direct or indirect contact with the head and/or body 230 of the user, thereby forming an electrically conductive path between the conductive layer 204 and the head and/or body 230 of the user. According to some embodiments, the base layer 304 is substantially electrically non-conductive and/or substantially static-dissipative. According to other embodiments, the base layer 304 may comprise a semiconductor. According to some embodiments, fabric 300 further comprises an electrically-insulating layer deposed between the base layer 304 and the ESD protection component 102. According to further embodiments, the ESD protection component 102 is preferably configured to move substantially in-tandem with the base layer 304.

In some non-limiting embodiments or aspects, the ESD component 102 may be formed on an insert that is formed separately from the outer shell 206. The insert can be removably or non-removably connected to the outer shell 206. For example, the ESD component 102 may be formed on the base layer 304, wherein the base layer 304 is co-molded with the outer shell 206 during manufacture of the outer shell. In this manner, the insert having the ESD component 102 is integrally formed with the inner surface 214 of the outer shell 206. In some non-limiting embodiments or aspects, the ESD component 102 may be formed on the base layer 304 that is configured to be thermoformed with the outer shell 206. The base layer 304 may be a high density polyethylene (HDPE), polyethylene terephthalate (PET), or other thermoplastic film. The ESD component 102 may be vapor deposited to the base layer 304 (using CVD or PVD) prior to joining the base layer 304 to the conductive layer 204 and/or inner surface 214 of the outer shell 206.

During injection molding of the outer shell 206, the insert may be placed over a core and the outer shell 206 can be injection molded/formed over the insert. Techniques for molding the insert with the outer shell 206 include overmolding, insert molding, and co-molding. In this manner, the insert having the ESD component 102 is formed integrally with the conductive layer 204 and/or the inner surface 214 of the outer shell 206 without the need for adhering or clipping the insert containing the ESD component 102 to the outer shell 206. In some embodiments or aspects, the insert having the ESD component 102 may be secured to the conductive layer 204 and/or the inner surface 214 using adhesive, ultrasonic bonding, one or more mechanical clips or fasteners, or via press fit. The insert containing the ESD component 102 may be removably or non-removably secured to the conductive layer 204 and/or the inner surface 214 of the outer shell 206.

According to some non-limiting embodiments or aspects, electrically conductive layer 204 is applied on an insert that is removably or non-removably connected to the outer shell 206 of the helmet. For example, the insert might be configured to connect to the outer shell 206 by at least one of the following: adhesive, one or more mechanical clips or fasteners, press fit, ultrasonic bonding, or any combination thereof. According to another embodiment, the insert further comprises a substrate made from thermoplastic film. According to at least one embodiment, the insert comprising the conductive layer 204 further comprises an evaporative cooling pad inside the cavity of the outer shell 206 defined by the inner surface 214 and/or interior if the helmet. This evaporative cooling pad, according to a further embodiment, comprises of a top waterproof, vapor permeable layer and a bottom waterproof, vapor permeable layer with a second cavity defined there between. According to yet a further embodiment, the top and bottom layers comprise a nylon material laminated with a waterproof and vapor permeable material. According to some embodiments, at least one of the top and bottom layers comprises polyurethane or polytetrafluoroethylene.

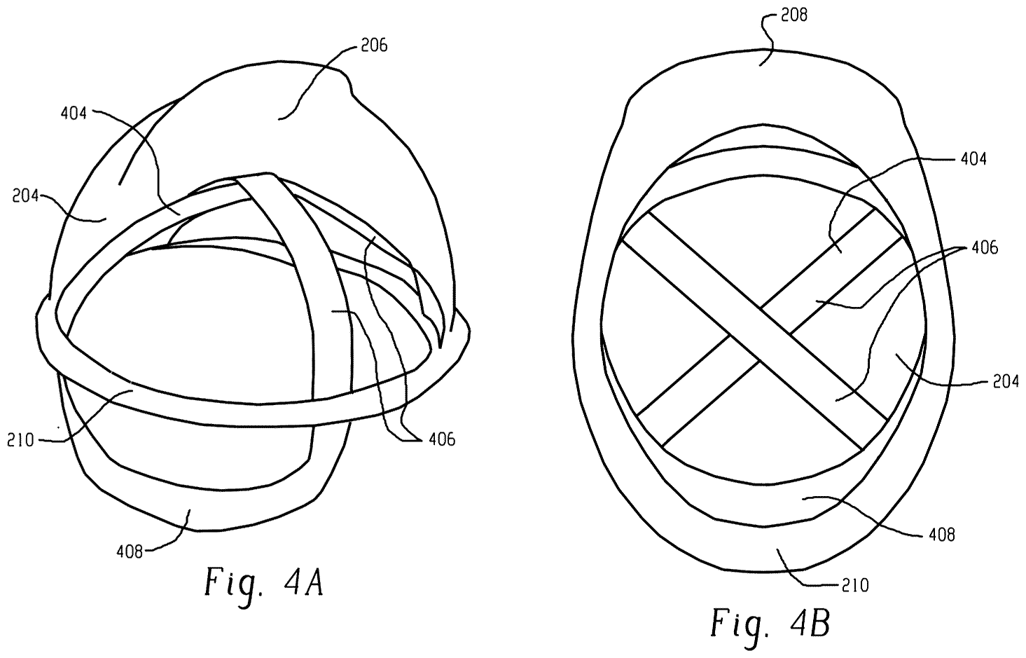

FIG. 4A is a posterior oblique cutaway view of a safety helmet 400 equipped with ESD component 102 which is integrated within the suspension system 404 of the safety helmet 400 in accordance with some non-limiting embodiments or aspects of the present disclosure. FIG. 4B is a bottom plan view of safety helmet 400. In addition to, or separately from, the aforementioned embodiments, the ESD protection component 102 comprises the suspension system 404 further comprising a first portion configured to be removably connected to the electrically conductive layer 204 via an electrically conductive connection mechanism, as well as a second portion configured to be in contact with the wearer of the helmet. The ESD protection component 102 is configured to provide a path for electric current to flow from the electrically conductive layer 204, through the electrically conductive connection mechanism, and to the wearer of the helmet. According to some embodiments, the electrically conductive connection mechanism comprises at least one of the following: a button, a stud, a socket, an eyelet, a snap, a clip, a rivet, a screw, a nail, a staple, a clasp, a pin, a bolt, a buckle, a hook, a zipper, or any combination thereof.

In the embodiment depicted in FIGS. 4A and 4B, the suspension system 404 further comprises a plurality of straps for supporting the shell 206 on the head of a user. In one particular exemplary embodiment, the suspension system 404 may comprise of a pliable material, such as fabric formed in the shape of a web, and may be attached to the conductive layer 204 and/or the inner surface 214 to comfortably position the helmet 200 on the head of a user. The suspension web may take a variety of forms including a plurality of straps extending radially from a central point or a mesh, which can take a variety of forms such as triangular, square, rectangular, hexagonal, for example. As depicted in FIGS. 4A and 4B, the suspension system 404 comprises both a set of intersecting crown straps 406 and a nape strap 408. In the embodiments of FIGS. 4A and 4B, the ESD component 102 is integrated within at least one of the plurality of straps, wherein the at least one strap is configured to either directly or indirectly electrically couple to both the conductive layer 204 of the safety helmet 400 and to the skin of the user. The suspension system 404 may be either removably or fixedly attached to the outer shell 206 of the safety helmet 400.

In the embodiment of FIGS. 4A and 4B, the ESD protection component 102 may further comprise a wide variety of helmet accessories and add-ons in addition to or in place of the suspension system 404, such as at least one of the following: a sweatband, a crown pad, a ratchet pad, a chin-strap, a ratchet assembly, a visor, a visor frame, a face shield, a chin-protector, a brow-guard, a liner, a sunshade, a sun shield, a cooling pad, a goggle retainer, a lanyard, earmuffs, a respirator, or any combination thereof. According to one such embodiment, the liner further comprises a cloth tube that covers at least one of the following features of the wearer: the ears, the mouth, the cheeks, the neck, or any combination thereof. According to another such embodiment, the liner comprises an extended nape portion and a wraparound collar for tucking into a coat or shirt of the wearer. According to yet another such embodiment, the liner comprises a skull-style cap. According to some embodiments, at least one ESD protection component 102 is washable. Examples of suspension systems with which the ESD protection component 102 can be used include, but are not limited to, suspension systems sold under the brand names Fas-Trac®, Staz-On®, and 1-Touch® which are manufactured and sold by MSA Safety Incorporated of Cranberry Township, Pennsylvania. According to an alternative embodiment, the suspension system comprises a swing ratchet.

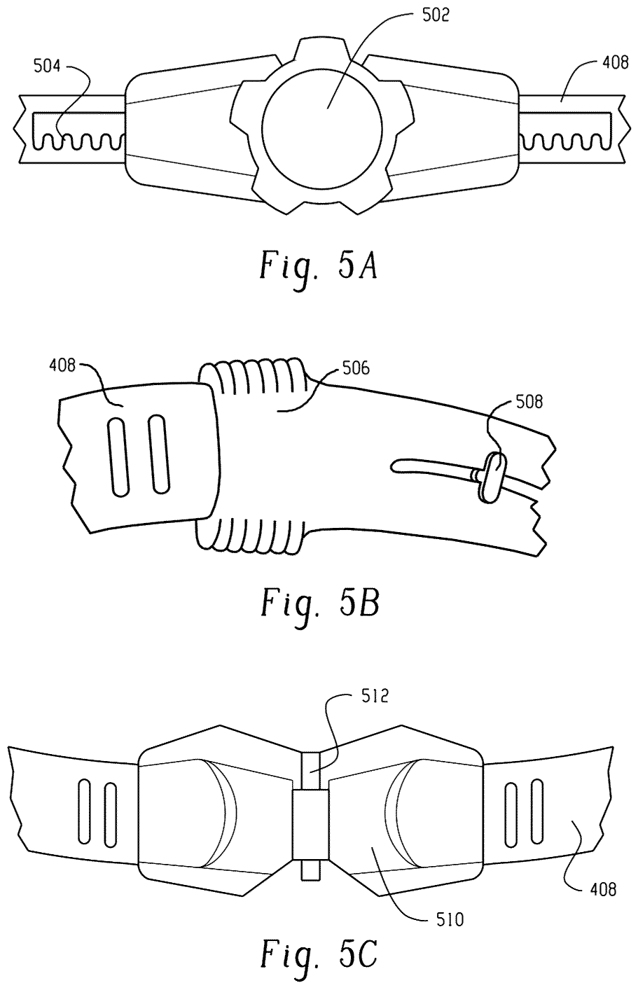

FIGS. 5A, 5B, and 5C depict close-up diagrams of three variations of adjustment assemblies 500 that may be part of the suspension system 400 integrated with the ESD protection component 102 in accordance with some non-limiting embodiments or aspects of the present disclosure. FIG. 5A depicts an adjustment assembly for a Fas-Trac® suspension system, and comprises a ratchet wheel 502 and teeth 504. FIG. 5B depicts an adjustment assembly for a Staz-On® suspension system, and comprises a lock 506 and a slide tab 508. FIG. 5C depicts an adjustment assembly for a 1-Touch® suspension system, and comprises a ratchet 510 and a release tab 512. As shown in FIGS. 5A, 5B, and 5C, each adjustment assembly 500 connects either side of the nape strap 408 together, and each adjustment assembly is preferably configured to be in direct contact with the skin of the user when tightened to securely fit the head of the user. According to the embodiments of FIGS. 5A, 5B, and 5C, the ESD protection component 102 comprises at least a portion of the surface area of the adjustment assemblies configured to contact the skin of the user and, in use, forms an electrically conductive and/or semiconductive path through the nape strap 408 to the conductive layer 204 of the of the safety helmet 400.

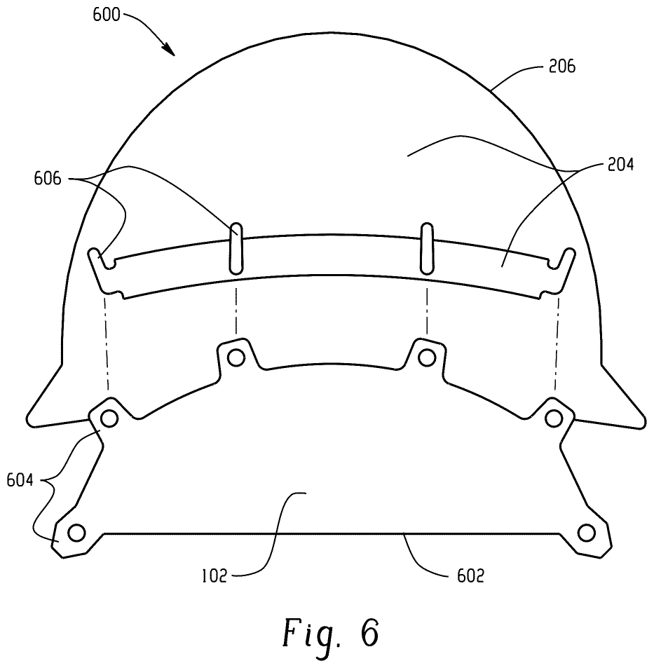

FIG. 6 is a cutaway side-view of a safety helmet 600 and a removable and/or disposable sweatband 602 that is oriented for installation within the helmet 600, wherein the sweatband 602 comprises the ESD protection component 102 in accordance with some non-limiting embodiments or aspects of the present disclosure. The sweatband 602, as depicted in FIG. 6, comprises sweat-absorbing fabric lined and/or impregnated with the ESD protection component 102 that is configured to be in direct contact with the skin of the head of the user when installed within the safety helmet 600. For installation, the sweatband 602 comprises a plurality of connection tabs 604 that attach to a plurality of corresponding connection receptacles 606 located within the safety helmet 600. The plurality of connection receptables 606 may be in direct contact with the conductive layer 204 (such as in the example of FIG. 2) and/or indirect contact with the conductive layer 204 (such as in the example of FIG. 4). The sweatband 602 and helmet 600 are configured such that at least one interface between a connection receptable 606 and an associated connection tab 604 forms an electrical path between the ESD protection component 102 of the sweatband 602 to the conductive layer 204 of the helmet 600. It should be noted that one or more of the plurality of connection receptables 606 may be interchangeable with one or more of the plurality of connection tabs 604 between the sweatband 602 and helmet 600 (e.g., the plurality of connection receptacles 606 could instead be located on the conductive and/or semiconductive sweatband 602 while the plurality of connection tabs 604 are located on the helmet 600). Furthermore, the plurality of connection tabs 604 and/or the plurality of connection receptacles 606 may be continuous. For example, they may form a zipper at their interface. According to some embodiments, the connection tabs 604 and/or connection receptacles 606 comprise at least one of the following: a button, a stud, a socket, an eyelet, a snap, a clip, a rivet, a screw, a nail, a staple, a clasp, a pin, a bolt, a buckle, a hook, a zipper, or any combination thereof.

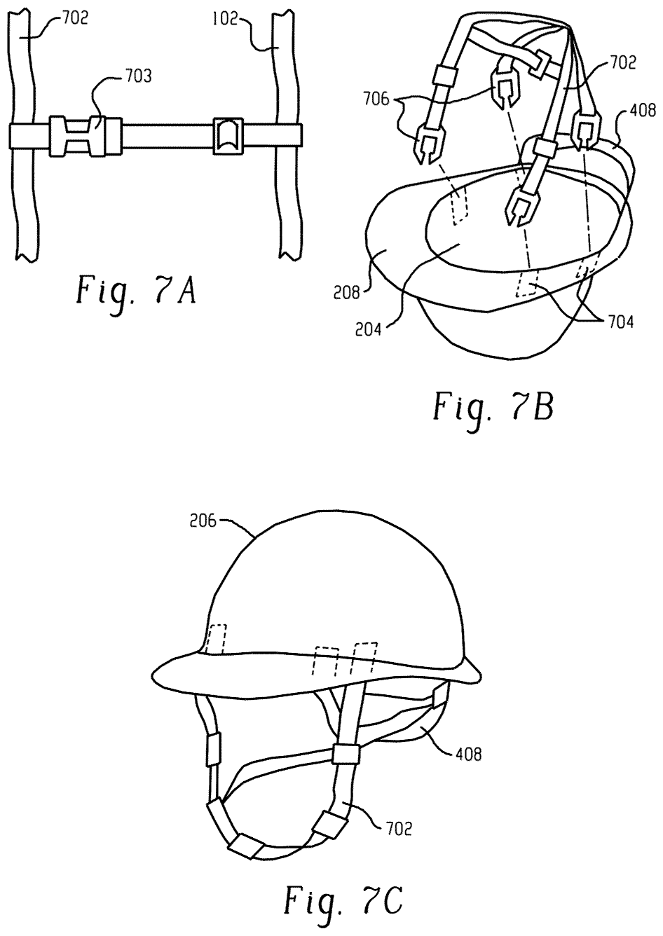

FIGS. 7A, 7B, and 7C together depict a chinstrap assembly comprising of a safety helmet 700 and a chinstrap 702 comprising the ESD protection component 102 in accordance with some non-limiting embodiments or aspects of the present disclosure. FIG. 7A depicts a detached chinstrap 702 comprising fabric straps that are at least partially lined with the ESD protection component 102. Preferably, the ESD protection component 102 is integrated throughout the chinstrap 702 so as to maximize direct or indirect points of contact with the head of the user. In the embodiment of FIG. 7A, the chinstrap 702 comprises a belt and/or buckle 703 that is at least partially electrically conductive and/or semiconductive and connected to the ESD protection component 102. FIG. 7A depicts a 4-point chinstrap, but other configurations with fewer or more points of contact, particularly a 2-point or 6-point chinstrap, are also contemplated. FIG. 7B depicts an oblique bottom view of the safety helmet 700 and the chinstrap 702, wherein the chinstrap 702 is oriented for installation within helmet 700. FIG. 7C depicts the safety helmet 700 complexed with the chinstrap 702 following installation of the chinstrap 702. The plurality of connection tabs 704 and the plurality of connection receptacles 706 are similar in configuration to the plurality of connection tabs 604 and the plurality of connection receptables 606, respectively.

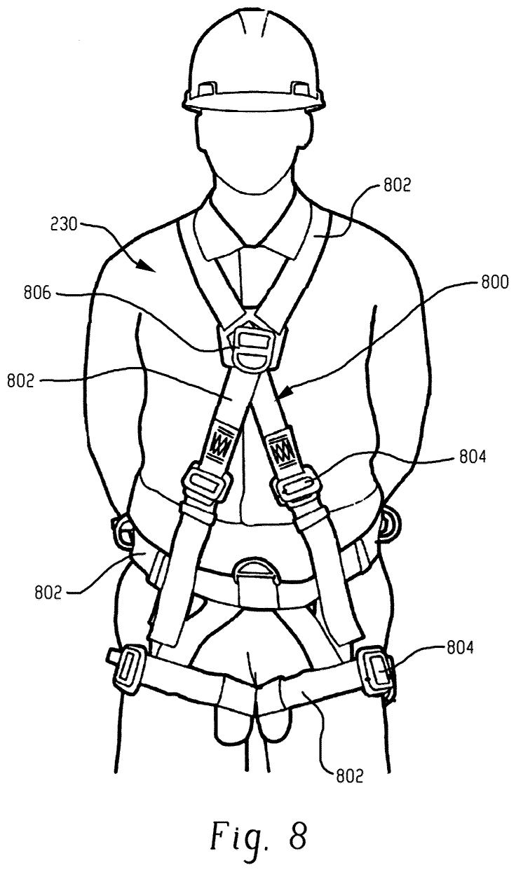

FIG. 8 depicts a safety harness 800 comprising the ESD protection component 102 in accordance with some non-limiting embodiments or aspects of the present disclosure. In addition to, or separately from, the aforementioned embodiments, the harness 800 comprises a plurality of straps 802 lined with the ESD protection component 102 and a plurality of electrically conductive components 804. At least one of the plurality of conductive components 804 is configured to participate in joining two or more straps of the plurality of ESD-lined straps 802 together. The harness 800 is configured to provide a path along at least one of the plurality of ESD-lined straps 802 for electrostatic charges to pass from at least one of the plurality of electrically conductive components 804 to the head and/or body 230 of the wearer. According to the embodiment of FIG. 8, the plurality of straps 802 converge to meet at at least one of the plurality of electrically conductive components 804 comprising an electrically conductive adjustment mechanism 806. According to an embodiment, the ESD protection component 102 comprises a first portion configured to be in contact with the electrically conductive adjustment mechanism, and a second portion configured to be in contact with a wearer of the harness system. According to further embodiments, the ESD protection component 102 is fixedly attached to at least one of the plurality of straps 802. In some embodiments, the plurality of straps 802 and/or the plurality of conductive components 804 comprise a semiconductor.

According to some embodiments, the plurality of straps 802 comprise a first strap configured for surrounding a first shoulder of a wearer, wherein the length of the first strap is adjustable via a first adjustment mechanism. Similarly, some embodiments further comprise a second strap configured for surrounding a second shoulder of the wearer, wherein the length of the second strap is adjustable via a second adjustment mechanism. Preferably, the first strap and the second strap converge to meet. Some embodiments further comprise yet a third strap configured for surrounding a waist of the wearer, wherein the length of the third strap is adjustable via a third adjustment mechanism. According to some embodiments, at least one adjustment mechanism comprises an electrically conductive component of the plurality of electrically conductive components 804. According to the embodiment depicted in FIG. 8, the safety harness 800 further comprises fourth and fifth straps that wrap around each of the wearer's legs, and are further adjustable via fourth and fifth adjustment mechanisms, respectively. The fourth and fifth straps are each connected to at least one other strap of the plurality of straps. As depicted in the non-limiting embodiment of FIG. 8, the fourth and fifth straps are connected to the third strap by fifth and sixth straps, respectively.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

Although the disclosure has been described in detail for the purpose of illustration based on what are currently considered to be the most practical and preferred embodiments or aspects, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

### Other Exemplary Embodiments

### Examples A

Example A1. A device, comprising:
a helmet comprising:
   an outer shell configured for surrounding a head of a wearer, and
   an electrically conductive layer disposed in an interior of the outer shell; and
an electrostatic discharge (ESD) protection component positioned in at least a portion of a cavity defined by the interior of the outer shell, the ESD protection component comprising:
   a first portion configured to be in contact with the electrically conductive layer, and
   a second portion configured to be in contact with the wearer of the helmet; and wherein the ESD protection component is configured to provide a path for electric current to flow between the electrically conductive layer and the wearer of the helmet.

A2. The device of example A1, wherein the second portion of the ESD protection component is configured to contact the skin on the head or neck of the wearer.

A3. The device of example A1, wherein the first portion of the ESD protection component comprises a first end and the second portion of the ESD protection component comprises a second end.

A4. The device of example A1, wherein the ESD protection component comprises circuitry that is configured to electrically couple the electrically conductive layer to the wearer, such that the electrically conductive layer and the wearer have the same voltage potential while the device is in use.

A5. The device of example A1, wherein the ESD protection component comprises at least one of the following: silver-plated nylon thread, carbon-suffused nylon, carbon black-loaded rubber, silver conductive monofilament, conductive foam, semiconductive material, ceramic material, or any combination thereof.

A6. The device of example A1, wherein the ESD protection component is configured to provide 360-degree contact with the wearer.

A7. The device of example A1, wherein the ESD protection component is contoured for closer fit with the wearer.

A8. The device of example A1, wherein the ESD protection component is configured to create a tight seal with the wearer.

A9. The device of example A1, wherein the ESD protection component comprises multiple points of contact with the wearer to ensure the path for electric current to flow stays intact.

A10. The device of example A3, wherein the first end is configured to extend to a top of the head of the wearer, and wherein the second end is configured to be in contact with a forehead of the wearer.

A11. The device of example A1, wherein the ESD protection component can be attached and/or replaced while a suspension system is assembled in the helmet.

A12. The device of example A1, wherein the ESD protection component is configured to electrically couple the electrically conductive layer to the wearer inside a high-voltage electric field.

A13. The device of example A1, wherein the ESD protection component is configured to prevent microshocks to the wearer.

A14. The device of example A1, wherein the ESD protection component is configured to prevent corona discharges from occurring on the wearer.

A15. The device of example A1, wherein the ESD protection component is configured to prevent the wearer from participating in triboelectric charging.

A16. The device of example A1, wherein the ESD protection component further comprises a resistor.

A17. The device of example A1, wherein the helmet is configured to provide dielectric protection up to 20,000 volts.

A18. The device of example A1, wherein the electrically conductive layer comprises at least one of the following: aluminum, gold, silver, copper, doped titanium dioxide, doped or undoped indium tin oxide, doped cerium oxide, doped manganese oxide, iron (III) oxide, cadmium sulfide, chromium trioxide, or any combination thereof.

A19. The device of example A1, wherein the helmet is at least one of the following: full-brimmed or cap-style, slotted or non-slotted, vented or non-vented, climbing or low-profile style, or any combination thereof.

A20. The device of example A1, wherein the helmet is configured for reverse donning.

A21. The device of example A1, wherein a brim of the helmet is textured for added grip when donning or doffing the helmet.

A22. The device of example A1, wherein the electrically conductive layer further comprises at least one of the following: a rotatable joint, a welding lug, a pivot hinge, a lamp bracket, a cord holder, an attachment rail, a lighting clip, a headlamp strap clip, a stowable slot adaptor, a sliding adjustment blade, or any combination thereof.

A23. The device of example A1, wherein the ESD protection component further comprises at least one of the following: a rotatable joint, a welding lug, a pivot hinge, a lamp bracket, a cord holder, an attachment rail, a lighting clip, a headlamp strap clip, a stowable slot adaptor, a sliding adjustment blade, or any combination thereof.

A24. The device of example A1, wherein the helmet comprises at least one of the following materials: polyethylene, Acrylonitrile Butadiene Styrene (ABS), Expanded Polystyrene (EPS), polypropylene, POM (Acetal), polyester, acrylic, clear polycarbonate, nylon, glass-reinforced nylon, heat-resistant nylon, High Density Polyethylene (HDPE), flame-resistant Kevlar fabric, phenolic, Polybutylene Terephthalate (PBT), propionate, epoxy-coated steel mesh, heavy-duty anodized aluminum, or any combination thereof.

A25. The device of example A1, wherein the outer shell comprises at least one safety helmet sold under the following brand names: V-Gard®, V-Gard C1®, V-Gard H1™, V-Gard H2™, V-Gard® 500, Topguard®, Smoothdome®, Skullgard®, Super V®, Comfo-Cap®, Thermalgard®, Nexus Climbing®, and Bump Cap.

A26. The device of example A1, wherein the electrically conductive layer is applied on an insert that is removably or non-removably connected to the outer shell of the helmet.

A27. The device of example A26, the insert further configured to connect to the outer shell by at least one of the following: adhesive, one or more mechanical clips or fasteners, press fit, ultrasonic bonding, or any combination thereof.

A28. The device of example A26, the insert further comprising an evaporative cooling pad inside the cavity of the outer shell defined by the inner surface, the evaporative cooling pad comprising: a top waterproof, vapor permeable layer and a bottom waterproof, vapor permeable layer with a second cavity defined there between.

A29. The device of example A26, the insert further comprising a substrate made from thermoplastic film.

A30 The device of example A28, wherein the top and bottom layers comprise a nylon material laminated with a waterproof and vapor permeable material.

A31. The device of example A28, wherein at least one of the top and bottom layers comprises polyurethane or polytetrafluoroethylene.

A32. The device of example A16, wherein the resistor has a resistance of less than 35 megohms.

### Examples B

Example B1. A device, comprising:
a helmet comprising:
   an outer shell configured for surrounding a head of a wearer; and
   an electrically conductive layer disposed in an interior of the outer shell;
an electrostatic discharge (ESD) protection component positioned in at least a portion of a cavity defined by the interior of the outer shell, the ESD protection component comprising:
   a first portion configured to be removably connected to the electrically conductive layer via an electrically conductive connection mechanism, and
   a second portion configured to be in contact with the wearer of the helmet; and
wherein the ESD protection component is configured to provide a path for electric current to flow from the electrically conductive layer, through the electrically conductive connection mechanism, and to the wearer of the helmet.

B2. The device of example B1, wherein the second portion of the ESD protection component is configured to connect to skin on the head or neck of the wearer.

B3. The device of example B1, wherein the first portion of the ESD protection component comprises a first end and the second portion of the ESD protection component comprises a second end.

B4. The device of example B1, wherein the ESD protection component comprises circuitry that is configured to electrically couple the electrically conductive layer to the wearer, such that the electrically conductive layer and the wearer have the same voltage potential while the device is in use.

B5. The device of example B1, wherein the ESD protection component comprises at least one of the following: silver-plated nylon thread, carbon-suffused nylon, carbon black-loaded rubber, silver conductive monofilament, conductive foam, semiconductive material, ceramic material, or any combination thereof.

B6. The device of example B1, wherein the ESD protection component is configured to provide 360-degree contact with the wearer.

B7. The device of example B1, wherein the ESD protection component is contoured for closer fit with the wearer.

B8. The device of example B1, wherein the ESD protection component is configured to create a tight seal with the wearer.

B9. The device of example B1, wherein the ESD protection component comprises multiple points of contact with the wearer to ensure the path for electric current to flow stays intact.

B10. The device of example B3, wherein the first end is configured to extend to a top of the head of the wearer, and wherein the second end is configured to be in contact with a forehead of the wearer.

B11. The device of example B1, wherein the ESD protection component further comprises at least one of the following: a suspension system, a sweatband, a crown pad, a ratchet pad, a chin-strap, a ratchet assembly, a visor, a visor frame, a face shield, a chin-protector, a brow-guard, a liner, a sunshade, a sun shield, a cooling pad, a goggle retainer, a lanyard, earmuffs, a respirator, or any combination thereof.

B12. The device of example B11, wherein the liner comprises a cloth tube that covers at least one of the following features of the wearer: the ears, the mouth, the cheeks, the neck, or any combination thereof.

B13. The device of example B11, wherein the liner comprises an extended nape portion and a wraparound collar for tucking into a coat or shirt of the wearer.

B14. The device of example B11, wherein the liner comprises a skull-style cap.

B15. The device of example B1, wherein the ESD protection component is washable.

B16. The device of example B11, wherein the suspension system comprises at least one of the following: an adjustment assembly for a Fas-Trac® suspension system, an adjustment assembly for a 1-Touch® suspension system, an adjustment assembly for a Staz-On® suspension system, a swing ratchet, or a combination thereof.

B17. The device of example B11, wherein the suspension system comprises a nape strap.

B18. The device of example B1, wherein the electrically conductive connection mechanism comprises at least one of the following: a button, a stud, a socket, an eyelet, a snap, a clip, a rivet, a screw, a nail, a staple, a clasp, a pin, a bolt, a buckle, a hook, a zipper, or any combination thereof.

B19. The device of example B1, wherein the ESD protection component is configured to electrically couple the electrically conductive layer to the wearer inside a high-voltage electric field.

B20. The device of example B1, wherein the ESD protection component is configured to prevent microshocks to the wearer.

B21. The device of example B1, wherein the ESD protection component is configured to prevent corona discharges from occurring on the wearer.

B22. The device of example B1, wherein the ESD protection component is configured to prevent the wearer from participating in triboelectric charging.

B23. The device of example B1, wherein the ESD protection component further comprises a resistor.

B24. The device of example B1, wherein the helmet is configured to provide dielectric protection up to 20,000 volts.

B25. The device of example B1, wherein the electrically conductive layer comprises at least one of the following: aluminum, gold, silver, copper, doped titanium dioxide, doped or undoped indium tin oxide, doped cerium oxide, doped manganese oxide, iron (III) oxide, cadmium sulfide, chromium trioxide, or any combination thereof.

B26. The device of example B1, wherein the helmet is at least one of the following: full-brimmed or cap-style, slotted or non-slotted, vented or non-vented, climbing or low-profile design, or any combination thereof.

B27. The device of example B1, wherein the helmet is configured for reverse donning.

B28. The device of example B1, wherein a brim of the helmet is textured for added grip when donning or doffing the helmet.

B29. The device of example B1, wherein the electrically conductive layer further comprises at least one of the following: a rotatable joint, a welding lug, a pivot hinge, a lamp bracket, a cord holder, an attachment rail, a lighting clip, a headlamp strap clip, a stowable slot adaptor, a sliding adjustment blade, or any combination thereof.

B30. The device of example B1, wherein the ESD protection component further comprises at least one of the following: a rotatable joint, a welding lug, a pivot hinge, a lamp bracket, a cord holder, an attachment rail, a lighting clip, a headlamp strap clip, a stowable slot adaptor, a sliding adjustment blade, or any combination thereof.

B31. The device of example B1, wherein the helmet comprises at least one of the following materials: polyethylene, Acrylonitrile Butadiene Styrene (ABS), Expanded Polystyrene (EPS), polypropylene, POM (Acetal), polyester, acrylic, clear polycarbonate, nylon, glass-reinforced nylon, heat-resistant nylon, High Density Polyethylene (HDPE), flame-resistant Kevlar fabric, phenolic, Polybutylene Terephthalate (PBT), propionate, epoxy-coated steel mesh, heavy-duty anodized aluminum, or any combination thereof.

B32. The device of example B1, wherein the outer shell comprises at least one safety helmet sold under the following brand names: V-Gard®, V-Gard C1®, V-Gard H1™, V-Gard H2™, V-Gard® 500, Topguard®, Smoothdome®, Skullgard®, Super V®, Comfo-Cap®, Thermalgard®, Nexus Climbing®, and Bump Cap.

B33. The device of example B1, wherein the electrically conductive layer is applied on an insert that is removably or non-removably connected to the outer shell of the helmet.

B34. The device of example B33, the insert further configured to connect to the outer shell by at least one of the following: adhesive, one or more mechanical clips or fasteners, press fit, ultrasonic bonding, or any combination thereof.

B35. The device of example B33, the insert further comprising an evaporative cooling pad inside the cavity of the outer shell defined by the inner surface, the evaporative cooling pad comprising: a top waterproof, vapor permeable layer and a bottom waterproof, vapor permeable layer with a second cavity defined there between.

B36. The device of example B33, the insert further comprising a substrate made from thermoplastic film.

B37. The device of example B35, wherein the top and bottom layers comprise a nylon material laminated with a waterproof and vapor permeable material.

B38. The device of example B35, wherein at least one of the top and bottom layers comprises polyurethane or polytetrafluoroethylene.

B39. The device of example B1, wherein the ESD protection component can be attached and/or replaced while a suspension system is assembled in the helmet.

### Examples C

Example C1. A device, comprising:
a helmet comprising:
   an outer shell configured for surrounding a head of a wearer, and
   an electrically conductive layer disposed in an interior of the outer shell;
a base layer positioned in at least a portion of a cavity defined by the interior of the outer shell; and
an electrostatic discharge (ESD) protection component fixedly attached to the base layer, the ESD protection component comprising:
   a first portion configured to be in contact with the electrically conductive layer, and
   a second portion configured to be in contact with the wearer of the helmet; and
wherein the ESD protection component is configured to provide a path for electric current to flow between the electrically conductive layer and the wearer of the helmet.

C2. The device of example C1, wherein the second portion of the ESD protection component is configured to contact the skin on the head or neck of the wearer.

C3. The device of example C1, wherein the first portion of the ESD protection component comprises a first end and the second portion of the ESD protection component comprises a second end.

C4. The device of example C1, wherein the ESD protection component comprises circuitry that is configured to electrically couple the electrically conductive layer to the wearer, such that the electrically conductive layer and the wearer have the same voltage potential while the device is in use.

C5. The device of example C1, wherein the ESD protection component comprises at least one of the following: silver-plated nylon thread, carbon-suffused nylon, carbon black-loaded rubber, silver conductive monofilament, conductive foam, semiconductive material, ceramic material, or any combination thereof.

C6. The device of example C1, wherein the ESD protection component is configured to provide 360-degree contact with the wearer.

C7. The device of example C1, wherein the ESD protection component is contoured for closer fit with the wearer.

C8. The device of example C1, wherein the ESD protection component is configured to create a tight seal with the wearer.

C9. The device of example C1, wherein the ESD protection component comprises multiple points of contact with the wearer to ensure the path for electric current to flow stays intact.

C10. The device of example C3, wherein the first end is configured to extend to a top of the head of the wearer, and wherein the second end is configured to be in contact with a forehead of the wearer.

C11. The device of example C1, wherein the ESD protection component can be attached and/or replaced while a suspension system is assembled in the helmet.

C12. The device of example C1, wherein the ESD protection component is configured to electrically couple the electrically conductive layer to the wearer inside a high-voltage electric field.

C13. The device of example C1, wherein the ESD protection component is configured to prevent microshocks to the wearer.

C14. The device of example C1, wherein the ESD protection component is configured to prevent corona discharges from occurring on the wearer.

C15. The device of example C1, wherein the ESD protection component is configured to prevent the wearer from participating in triboelectric charging.

C16. The device of example C1, wherein the ESD protection component further comprises a resistor.

C17. The device of example C1, wherein the helmet is configured to provide dielectric protection up to 20,000 volts.

C18. The device of example C1, wherein the electrically conductive layer comprises at least one of the following: aluminum, gold, silver, copper, doped titanium dioxide, doped or undoped indium tin oxide, doped cerium oxide, doped manganese oxide, iron (III) oxide, cadmium sulfide, chromium trioxide, or any combination thereof.

C19. The device of example C1, wherein the helmet is at least one of the following: full-brimmed or cap-style, slotted or non-slotted, vented or non-vented, climbing or low-profile style, or any combination thereof.

C20. The device of example C1, wherein the helmet is configured for reverse donning.

C21. The device of example C1, wherein a brim of the helmet is textured for added grip when donning or doffing the helmet.

C22. The device of example C1, wherein the electrically conductive layer further comprises at least one of the following: a rotatable joint, a welding lug, a pivot hinge, a lamp bracket, a cord holder, an attachment rail, a lighting clip, a headlamp strap clip, a stowable slot adaptor, a sliding adjustment blade, or any combination thereof.

C23. The device of example C1, wherein the ESD protection component further comprises at least one of the following: a rotatable joint, a welding lug, a pivot hinge, a lamp bracket, a cord holder, an attachment rail, a lighting clip, a headlamp strap clip, a stowable slot adaptor, a sliding adjustment blade, or any combination thereof.

C24. The device of example C1, wherein the helmet comprises at least one of the following materials: polyethylene, Acrylonitrile Butadiene Styrene (ABS), Expanded Polystyrene (EPS), polypropylene, POM (Acetal), polyester, acrylic, clear polycarbonate, nylon, glass-reinforced nylon, heat-resistant nylon, High Density Polyethylene (HDPE), flame-resistant Kevlar fabric, phenolic, Polybutylene Terephthalate (PBT), propionate, epoxy-coated steel mesh, heavy-duty anodized aluminum, or any combination thereof.

C25. The device of example C1, wherein the outer shell comprises a safety helmet sold under at least one of the following brand names: V-Gard®, V-Gard C1®, V-Gard H1™, V-Gard H2™, V-Gard® 500, Topguard®, Smoothdome®, Skullgard®, Super V®, Comfo-Cap®, Thermalgard®, Nexus Climbing®, and Bump Cap.

C26. The device of example C1, wherein the electrically conductive layer is applied on an insert that is removably or non-removably connected to the outer shell of the helmet.

C27. The device of example C26, the insert further configured to connect to the outer shell by at least one of the following: adhesive, one or more mechanical clips or fasteners, press fit, ultrasonic bonding, or any combination thereof.

C28. The device of example C26, the insert further comprising an evaporative cooling pad inside the cavity of the outer shell defined by the inner surface, the evaporative cooling pad comprising: a top waterproof, vapor permeable layer and a bottom waterproof, vapor permeable layer with a second cavity defined there between.

C29. The device of example C26, the insert further comprising a substrate made from thermoplastic film.

C30. The device of example C28, wherein the top and bottom layers comprise a nylon material laminated with a waterproof and vapor permeable material.

C31. The device of example C28, wherein at least one of the top and bottom layers comprises polyurethane or polytetrafluoroethylene.

C32. The device of example C1, wherein the base layer comprises a flexible substrate.

C33. The device of example C1, wherein the base layer comprises a textile.

C34. The device of example C1, wherein the base layer is substantially electrically non-conductive.

C35. The device of example C1, the device further comprising an insulating layer deposed between the base layer and the ESD protection component.

C36. The device of example C1, wherein the ESD protection component is configured to move substantially in-tandem with the base layer.

C37. The device of example C1, wherein the base layer is substantially static-dissipative.

C38. The device of example C1, wherein the base layer comprises an anti-static cloth.

C39. The device of example C1, wherein the base layer comprises knitted ribbon.

C40. The device of example C1, wherein the base layer comprises spandex.

C41. The device of example C1, wherein the base layer comprises a hook-and-loop fastener.

### Examples D

Example D1. A device, comprising:
a harness system comprising a plurality of straps that converge to meet at at least one electrically conductive adjustment mechanism; and
an electrostatic discharge (ESD) protection component fixedly attached to at least one of the plurality of straps, the ESD protection component comprising:
   a first portion configured to be in contact with the at least one electrically conductive adjustment mechanism, and
   a second portion configured to be in contact with a wearer of the harness system; and
wherein the ESD protection component is configured to provide a path for electric current to flow between the at least one electrically conductive adjustment mechanism and the wearer of the harness system.

D2. The device of example D1, wherein the plurality of straps comprises a first strap configured for surrounding a first shoulder of a wearer, wherein the length of the first strap is adjustable via a first adjustment mechanism.

D3. The device of example D2, wherein the plurality of straps comprises a second strap configured for surrounding a second shoulder of the wearer, wherein the length of the second strap is adjustable via a second adjustment mechanism.

D4. The device of example D3, wherein the plurality of straps comprises a third strap configured for surrounding a waist of the wearer, wherein the length of the third strap is adjustable via a third adjustment mechanism.

D5. The device of example D3, wherein the wherein the first strap and the second strap converge to meet.

D6. The device of example D1, wherein the plurality of straps comprises a leg strap configured for surrounding a leg of the wearer, wherein the length of the leg strap is adjustable via an adjustment mechanism.

D7. The device of example D6, wherein the leg strap is connected to at least one other strap of the plurality of straps.

D8. The device of example D1, wherein the first portion of the ESD protection component comprises a first end and the second portion of the ESD protection component comprises a second end.

D9. The device of example D1, wherein the ESD protection component comprises circuitry that is configured to electrically couple the at least one electrically conductive adjustment mechanism to the wearer, such that the at least one electrically conductive adjustment mechanism and the wearer have the same voltage potential while the device is in use.

D10. The device of example D1, wherein the ESD protection component comprises at least one of the following: silver-plated nylon thread, carbon-suffused nylon, carbon black-loaded rubber, silver conductive monofilament, conductive foam, semiconductive material, ceramic material, or any combination thereof.

D11. The device of example D1, wherein the ESD protection component is configured to provide 360-degree contact with the wearer.

D12. The device of example D1, wherein the ESD protection component is contoured for closer fit with the wearer.

D13. The device of example D1, wherein the ESD protection component is configured to create a tight seal with the wearer.

D14. The device of example D1, wherein the ESD protection component comprises multiple points of contact with the wearer to ensure the path for electric current to flow stays intact.

D15. The device of example D1, wherein the at least one electrically conductive adjustment mechanism comprises at least one of the following: a button, a stud, a socket, an eyelet, a snap, a clip, a rivet, a screw, a nail, a staple, a clasp, a pin, a bolt, a buckle, a hook, a zipper, or any combination thereof.

D16. The device of example D1, wherein the ESD protection component is configured to electrically couple the at least one electrically conductive adjustment mechanism to the wearer inside a high-voltage electric field.

D17. The device of example D1, wherein the ESD protection component is configured to prevent microshocks to the wearer.

D18. The device of example D1, wherein the ESD protection component is configured to prevent corona discharges from occurring on the wearer.

D19. The device of example D1, wherein the ESD protection component is configured to prevent the wearer from participating in triboelectric charging.

D20. The device of example D1, wherein the ESD protection component further comprises a resistor.

D21. The device of example D1, wherein the at least one electrically conductive adjustment mechanism comprises at least one of the following: aluminum, gold, silver, copper, doped titanium dioxide, doped or undoped indium tin oxide, doped cerium oxide, doped manganese oxide, iron (III) oxide, cadmium sulfide, chromium trioxide, or any combination thereof.

D22. The device of example D1, wherein the harness system comprises at least one of the following materials: polyethylene, Acrylonitrile Butadiene Styrene (ABS), Expanded Polystyrene (EPS), polypropylene, POM (Acetal), polyester, acrylic, clear polycarbonate, nylon, glass-reinforced nylon, heat-resistant nylon, High Density Polyethylene (HDPE), flame-resistant Kevlar fabric, phenolic, Polybutylene Terephthalate (PBT), propionate, epoxy-coated steel mesh, heavy-duty anodized aluminum, or any combination thereof.

For purposes of the description herein, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary.

All numbers and ranges used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first,” “second,” and the like are not intended to refer to any particular order or chronology, but refer to different conditions, properties, or elements.

The term “at least” is synonymous with “greater than or equal to.”

As used herein, “at least one of” is synonymous with “one or more of.” For example, the phrase “at least one of A, B, or C” means any one of A, B, or C, or any combination of any two or more of A, B, or C. For example, “at least one of A, B, or C” includes one or more of A alone; or one or more B alone; or one or more of C alone; or one or more of A and one or more of B; or one or more of A and one or more of C; or one or more of B and one or more of C; or one or more of all of A, B, and C.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments or aspects.

The terms “comprises,” “comprising,” or any other variations thereof, are intended to cover a non-exclusive inclusion, such that a setup, device, or method that comprises a list of components or steps does not include only those components or steps but may include other components or steps not expressly listed or inherent to such setup, device, or method. In other words, one or more elements in a system or apparatus proceeded by “comprises . . . a” does not, without more constraints, preclude the existence of other elements or additional elements in the system or method.

The terms “includes,” “including,” or any other variations thereof are intended to cover a non-exclusive inclusion such that a setup, device, or method that includes a list of components or steps does not include only those components or steps but may include other components or steps not expressly listed or inherent to such setup, device, or method. In other words, one or more elements in a system or apparatus proceeded by “includes . . . a” does not, without more constraints, preclude the existence of other elements or additional elements in the system or method.

The terms “an embodiment,” “embodiment,” “embodiments,” “the embodiment,” “the embodiments,” “one or more embodiments,” “some non-limiting embodiments or aspects,” and “one embodiment” mean “one or more (but not all) embodiments of the present disclosure” unless expressly specified otherwise. A description of an embodiment with several components in communication with each other does not imply that all such components are required. On the contrary, a variety of optional components is described to illustrate the wide variety of possible embodiments of the disclosure.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least in partially on” unless explicitly stated otherwise. The term “some non-limiting embodiments or aspects” means “one or more (but not all) embodiments or aspects of the disclosure(s)” unless expressly specified otherwise. A description of some non-limiting embodiments or aspects with several components in communication or combination with each other does not imply that all such components are required. On the contrary, a variety of optional components is described to illustrate the wide variety of possible embodiments of the disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments or aspects of the disclosure need not include the device itself.

As discussed herein, certain operations may be performed in a different order, modified, or removed. Moreover, steps may be added to methods described herein and still conform to the described embodiments. Further, operations described herein may occur sequentially or certain operations may be processed in parallel.

In the detailed description of the embodiments of the disclosure above, reference is made to the accompanying drawings that form a part hereof, and in which are shown by way of illustration specific embodiments in which the disclosure may be practiced. It should be understood, however, that it is not intended to limit the disclosure to the forms disclosed, but on the contrary, the disclosure is to cover all modifications, equivalents, and alternatives falling within the spirit and the scope of the disclosure. It is to be understood that other embodiments may be utilized and that changes may be made without departing from the scope of the present disclosure. The following description is, therefore, not to be taken in a limiting sense.

What is claimed is:

1. A device, comprising:
a helmet comprising:
an outer shell configured for surrounding a head of a wearer, and
an electrically conductive layer disposed in an interior of the outer shell; and
an electrostatic discharge (ESD) protection component positioned in at least a portion of a cavity defined by the interior of the outer shell, the ESD protection component comprising:
a first portion configured to be in contact with the electrically conductive layer, and
a second portion configured to be in contact with the wearer of the helmet; and
wherein the ESD protection component is configured to provide a path for electric current to flow between the electrically conductive layer and the wearer of the helmet.

2. The device of claim 1, wherein the second portion of the ESD protection component is configured to contact the skin on the head or neck of the wearer.

3. The device of claim 1, wherein the first portion of the ESD protection component comprises a first end and the second portion of the ESD protection component comprises a second end.

4. The device of claim 1, wherein the ESD protection component comprises circuitry that is configured to electrically couple the electrically conductive layer to the wearer, such that the electrically conductive layer and the wearer have the same voltage potential while the device is in use.

5. The device of claim 1, wherein the ESD protection component comprises at least one of the following: silver-plated nylon thread, carbon-suffused nylon, carbon black-loaded rubber, silver conductive monofilament, conductive foam, semiconductive material, ceramic material, or any combination thereof.

6. The device of claim 1, wherein the ESD protection component is configured to provide 360-degree contact with the wearer.

7. The device of claim 1, wherein the ESD protection component is contoured for closer fit with the wearer.

8. The device of claim 1, wherein the ESD protection component is configured to create a tight seal with the wearer.

9. The device of claim 1, wherein the ESD protection component comprises multiple points of contact with the wearer to ensure the path for electric current to flow stays intact.

10. The device of claim 1, wherein the ESD protection component is configured to electrically couple the electrically conductive layer to the wearer inside a high-voltage electric field.

11. The device of claim 1, wherein the ESD protection component is configured to prevent microshocks to the wearer.

12. The device of claim 1, wherein the helmet is at least one of the following: full-brimmed or cap-style, slotted or non-slotted, vented or non-vented, climbing or low-profile style, or any combination thereof.

13. The device of claim 1, wherein the helmet is configured for reverse donning.

14. A device, comprising:
a helmet comprising:
an outer shell configured for surrounding a head of a wearer; and
an electrically conductive layer disposed in an interior of the outer shell;
an electrostatic discharge (ESD) protection component positioned in at least a portion of a cavity defined by the interior of the outer shell, the ESD protection component comprising:
a first portion configured to be removably connected to the electrically conductive layer via an electrically conductive connection mechanism, and
a second portion configured to be in contact with the wearer of the helmet; and
wherein the ESD protection component is configured to provide a path for electric current to flow from the electrically conductive layer, through the electrically conductive connection mechanism, and to the wearer of the helmet.

15. The device of claim 14, wherein the second portion of the ESD protection component is configured to contact the skin on the head or neck of the wearer.

16. The device of claim 14, wherein the ESD protection component comprises circuitry that is configured to electrically couple the electrically conductive layer to the wearer, such that the electrically conductive layer and the wearer have the same voltage potential while the device is in use.

17. The device of claim 14, wherein the ESD protection component further comprises at least one of the following: a suspension system, a sweatband, a crown pad, a ratchet pad, a chin-strap, a ratchet assembly, a visor, a visor frame, a face shield, a chin-protector, a brow-guard, a liner, a sunshade, a sun shield, a cooling pad, a goggle retainer, a lanyard, earmuffs, a respirator, or any combination thereof.

18. The device of claim 14, wherein the ESD protection component can be attached to the safety helmet and/or replaced within the safety helmet while a suspension system is assembled in the safety helmet.

19. The device of claim 14, wherein the electrically conductive connection mechanism comprises at least one of the following: a button, a stud, a socket, an eyelet, a snap, a clip, a rivet, a screw, a nail, a staple, a clasp, a pin, a bolt, a buckle, a hook, or any combination thereof.

20. A device, comprising:
a helmet comprising:
an outer shell configured for surrounding a head of a wearer, and
an electrically conductive layer disposed in an interior of the outer shell;
a base layer positioned in at least a portion of a cavity defined by the interior of the outer shell; and
an electrostatic discharge (ESD) protection component fixedly attached to the base layer, the ESD protection component comprising:
a first portion configured to be in contact with the electrically conductive layer, and
a second portion configured to be in contact with the wearer of the helmet; and
wherein the ESD protection component is configured to provide a path for electric current to flow between the electrically conductive layer and the wearer of the helmet.
